(19) United States
(12) Patent Application Publication
(10) Pub. No.: US 2002/0153736 A1
(43) Pub. Date: Oct. 24, 2002

(54) Sliding deck for use in motor vehicle applications

(76) Inventor: Phillip Kent Goodyear, Arroyo Seco, NM (US)

Correspondence Address: Luis M. Ortiz, Ortiz & Lopez, PLLC, Registered Patent Attorney, P.O. Box 7720, Dallas, TX, 75209, US

(21) Appl. No.: 10/105,176

(22) Filed: Mar. 25, 2002

Related U.S. Application Data
(60) Provisional application No. 60/279,201, filed on Mar. 27, 2001.

(51) Int. Cl. B62D 33/02

(52) U.S. Cl. 296/26.01

(57) ABSTRACT

Systems associated with a motor vehicle for facilitating the loading, unloading and carriage of cargo. A preferred embodiment includes a frame securely mounted to a floor associated with a cargo carrying area of a motor vehicle. The frame further included a plurality of rollers rotatably attached to the frame. A deck is supported by the rollers and can slide along the rollers from a stowed position within a motor vehicles cargo carrying area to an extended position with respect to said cargo carrying area. In another embodiment, the deck can be slidably secured to the frame by rails mounted to the deck. The cargo-carrying system of the present invention is generally designed for use in the bed of a pick-up truck, or cargo area of an SUV or Van, and to better facilitate the loading and unloading of heavy materials. The present invention can also provide a working platform and can further include the deployment of side extension wings for extending the surface area of the deck. Additional hardware can be optionally associated with the system including: locking mechanisms, stopping mechanisms, metallic outer layers for the deck, support legs to support the deck when it is extended.

### PRIORITY

This application claims priority to a Provisional Patent Application, Serial No. 60/279,201, filed Mar. 27, 2001, entitled “Prosled.”

### TECHNICAL FIELD OF THE INVENTION

The present invention is generally related to cargo carrying equipment. More particularly the present invention is related to cargo carrying equipment adapted for use with motor vehicles in a manner that facilitates loading and unloading activities. The present invention is also related to materials useful for manufacturing cargo-carrying equipment useful for motor vehicle applications. The present invention is also related to a slidable deck for use with a motor vehicle to facilitate the loading, carriage and unloading of cargo.

### BACKGROUND

Every day, many people encounter difficulty with the loading and unloading into and out of motor vehicles tools, materials or equipment needed for work or recreation. In the construction industry, for example, many workers' most teediest chore involves the pushing, pulling and tugging required to get tools, toolboxes and sheet of hard-to-handle wood, brick or sacks of concrete situated within and/or retrieved from the back of a pickup truck bed. Workers often encounter smashed fingers, splinters, cuts, sprains and bruises from trying to maneuver themselves, tools or materials within or about the back of a truck or utility vehicle. At the end of the day, workers will again find themselves forced to repeat the process of loading tools and materials into a motor vehicle's cargo area and again encountering the hazards associated with such effort. Most people tire from crawling in and out of truck beds or cargo vans on their hands and knees to get tools, materials or equipment into or out of their vehicles.

There is a need to better facilitate the loading and unloading of tools, equipment or materials into and out of motor vehicles. Although some means well known in the art provide for carrying cargo, there still seems to be a lack of utility in the prior art associated with carrying and handling cargo, particularly when used with motor vehicles. Furthermore, most prior art alternatives provide industrial solutions that are not practical for most common household or small business uses. A few examples of prior art cargo carrying and handling solutions include: ramps associated with moving vans, hydraulic-actuated lifts; dump trucks beds, and flat beds adapted for use with pickup trucks.

Bed liners are a popular means for providing a carrying medium integrated with the back of pickup truck beds. Bed liners are well known in the general consumer market for carrying lighter cargo loads and also providing protection to paint and metal associated with the bed of a pickup. Another benefit associated with truck bed liners can be found with the durable plastic materials utilized to manufacture them. Materials are typically vinyl-based and add little weight to a vehicle's overall curb weight. Truck bed liners however, are nothing more than a protective liner for truck beds and do little to relieve workers from manual effort associated With loading material into or unloading material from, for example, the back of a truck bed.

What is needed are means for facilitating the loading and unloading of cargo onto and out of a motor vehicle with relative ease, while still facilitating the safe carriage of cargo within a motor vehicle. The present inventor has recognized the shortcomings of the prior art and now presents novel means for facilitating the loading and unloading of tools, materials and equipment to/from motor vehicles.

### SUMMARY OF THE INVENTION

The present invention addresses the need for cargo carrying systems integratable with motor vehicles. The present invention is capable of, among other things, facilitating the loading and unloading of tools, materials and equipment associated with the use of motor vehicles while also facilitating the safe carriage of cargo within a motor vehicle.

In accordance with aspects of the present invention, a system that can be associated with a motor vehicle is described for facilitating the loading, unloading and carriage of cargo.

In accordance with an aspect of the present invention, a frame can be securely mounted to a floor associated with a cargo carrying area of a motor vehicle. The frame further includes a plurality of rollers rotatably attached to the frame. A deck for carrying cargo is generally supported by the rollers and can slide along the rollers from a stowed position within a motor vehicles cargo carrying area to an extended position with respect to the cargo carrying area.

In accordance with another aspect of the present invention, a deck can be slidably secured to the frame by rails mounted to the deck. The system can include a frame securely mounted to a floor associated with a cargo carrying area of a motor vehicle, a plurality of rollers rotatably attached to the frame, and a deck slidably secured by the frame.

In accordance with another aspect of the present invention, during use the deck can slide along a frame and on the plurality of rollers associated with the frame, from a stowed position to an extended position with respect to a cargo carrying area within a motor vehicle to thereby facilitate the loading, carrying and unloading of cargo. The cargo-carrying system of the present invention can be designed for use in the bed of a pick-up truck and cargo areas of a sport utility vehicle (SUV) or van, as well as other possible civilian, military, industrial and commercial motor vehicle adaptations and applications that can be appreciated by those skilled in the art.

In accordance with another aspect of the present invention, a deck can provide a working platform and can further include side extensions wings for providing more work area useful at onsite construction projects. For example, the present invention can also provide a working surface that can extend to greater than 32 square feet when used within an eight foot long pick-up truck bed applications (8′×4′), but can also be adjusted to larger or smaller geometries, depending on the application (e.g., shorter applications can include a smaller cargo area associated with the rear of an SUV or van).

In accordance with another aspect of the present invention, side extensions wings or wings can be attached or hinged on the edge or outer edges of the deck in order to provide larger workspaces or useable work areas for material layout and fabrication operations.

In accordance with another aspect of the present invention, the present system can carry heavy loads, loads that can exceed 1500 pounds in some applications. Accordingly, additional hardware (e.g., power tools) can be mounted to the deck.

In accordance with another aspect of the present invention, an electrical power source can be provided as a component integrated with a load bearing, slidable deck.

It is another aspect of the present invention to provide a movable (rolling) platform (deck) designed to facilitate the loading and unloading of heavy or light weight tool, equipment and/or materials in any truck or utility vehicle. The present invention can be adapted to fits into both long (8 ft) and short (6 ft) bed trucks, and can be adapted to fit into opening in vans, sport utility vehicles (SUVs) and other utility vehicles of various sizes.

In accordance with another aspect of the present invention, the system can be easily installed and can be removed for use in alternative vehicles.

In accordance with other aspect of the present invention, lightweight, virtually indestructible materials can be used to create a movable work platform that will fit into any motor vehicle adapted for carrying cargo (e.g., trucks, vans, utility vehicles, etc.). Materials can include honeycomb construction for the deck, and the inclusion of metallic outer layers disposed on the top and/or bottom surfaces of the deck. Hardware, such as the frame, can be constructed using metal or aluminum.

### BRIEF DESCRIPTION OF THE DRAWINGS

The summarized and other features, aspects and advantages of the present invention will become better understood with regard to the following description, appended claims and accompanying drawings where:

FIG. 1 is an illustration of a sliding deck system in accordance with an embodiment of the present invention, installed within a truck bed;

FIG. 2 is an illustration of system components for a deck assembly in accordance with another embodiment of the present invention;

FIG. 3A is an illustration of system components for a roller assembly in accordance with yet another embodiment of the present invention;

FIG. 3B is an illustration of unassembled system components for a roller assembly in accordance with yet another embodiment of the present invention;

FIG. 4 is a horizontal cross sectional view of upper and lower unit sections in interacting assembly attached to the floor of a vehicle in accordance with an embodiment of the present invention;

FIG. 5 is an illustration from underneath the system where an assembled sliding deck unit and components are shown in accordance with embodiments of the present invention;

FIG. 6 is an illustration of extensions attachable to the left and right of a deck near the head portion (front) of a deck and the incorporation and use of support legs located near the head portion of the deck, in accordance with additional embodiments of the present invention;

FIG. 7 is an illustration of combination toolbox and worktable apparatuses securely mounted to the deck of the present invention in accordance with another embodiment of the present invention; and

FIG. 8 is an illustration of a van adapted to that takes advantage of the present invention at a rear cargo area and a side slider-door area in accordance with other embodiments of the present invention.

### DETAILED DESCRIPTION OF THE INVENTION

Referring to FIG. 1, a preferred embodiment of the present invention generally referred to by numeral 100 includes a sliding deck 110 and a plurality of rollers 120 attached to a frame 130. The frame 130 (and associated rollers 120) is securely mountable to a bed 140 or floor associated with a motor vehicle 150.

The present invention preferably utilizes a roller system (i.e., rollers 120 and frame 130) in its design rather than a captured track system (i.e., not shown, but known in the art as used in smaller form with many file cabinets and dresser drawers) because a roller system facilitates ease of weight movement and can reduce the possibility of jamming due to dirt, rocks, ice or other objects. It is generally more difficult to jam a roller system. The uniquely designed roller system can thus support the deck 110 of the present invention and a significant load borne by the deck 110, thus allowing for ease of use and maximizing load capacity. A roller system can distribute the weight of the deck evenly, which can enable the use of lightweight, durable deck systems.

The present invention can be taught in detail as upper and lower unit stages. Referring to FIG. 2, the upper unit stage 200 of the present invention will now be described. A decking panel 210 can be formed from a honeycomb plastic material 212 (as shown from the cutout view). The deck 210 can also be made of plastic panels or panels formed of other durable plastic or composite materials known in the art. Decks 210 can include an internal honeycomb construction 212 and flat outer upper surface 205 and flat outer lower surface (not shown, but similar in construction to upper surface 205), and each surface (lower and upper 205) can be configured with smooth and/or adhesive qualities (i.e., rubber, sandpaper, or textured) in order to promote/reduce gliding (i.e., on upper surface 205) or prevent sliding or shifting of cargo during motor vehicle movement.

I-beam supports hardware serving as deck rails 220 can be secured to the lower surface (not shown) of the deck 210 by adhesive 207 or mechanical means known in the art. For example, the deck rails 115 can be secured onto the lower surface of the deck by pressure sensitive adhesive 207 (as shown), bolts, screws, rivets and/or any combination of means known in the mechanical and manufacturing arts. Adhesives 207, however, can preclude the need for extensive drilling, tapping or bolting of hardware to a motor vehicles cargo bed or floor.

A durable plastic honeycomb design, when incorporated into the present invention, can act as a continuous I-beam with a flexible strength of over 1500 psi. The deck 210 can include an aluminum surfaces or skins 235 and 240 on either or both of the upper 215 and lower (not shown) surfaces of the deck 210. The deck 210 can also include molded edges 215 for further protection and added durability/integrity.

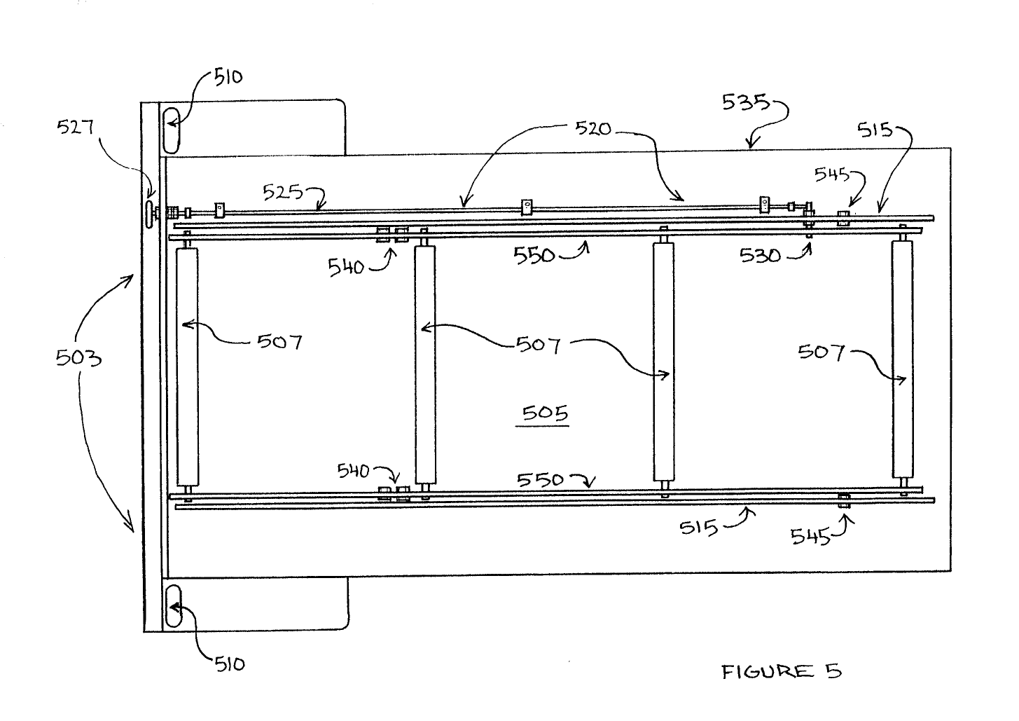

Additional area can be provided to the deck 210 with attachable extension wings 235 that can be mounted on the outer edge of the deck as shown in the Figure. Handles 230, 232 can be strategically placed for hand safety and optimal operation of the deck 's 210 locking mechanism 260 described in more detail in FIG. 5 below. Handles can be take the form of holes 230 formed into the deck, or as a handle attachment 232 that spans most of the length of the leading end of the deck as shown in the Figure.

Materials for the deck 210 and associated hardware should take into consideration rust, temperature and physical use. For example, materials for a deck can preferably be rustproof, flame retardant, UV resistant, highly durable and unaffected by temperature variations. When used, an aluminum skin (235 and 240) can also be covered with a material layer 250 to provide resistance to marring and can also provide the aluminum surface area with graphics. The material layer 250 can be made of polypropylene. The material layer 250 can also be used to prevent or promote cargo sliding along the top surface of the deck. The entire panel is then configured as the sliding deck as illustrated in FIG. 1.

Referring to FIG. 3, the deck assembly can be slidably secured to a roller assembly 300 that is mounted to a vehicle via a frame consisting of roller assembly rails 305 and slats 335. The deck 210 can be secured by its deck rails 220 via roller assembly rails 305 and supported by rollers 315 mounted to the roller assembly rails 305. It should be appreciated, however, that deck 210 may be allowed to glide freely over rollers 315 in an outwardly and inwardly motion with respect to the cargo area of the motor vehicle. For safety reason that will become apparent after further teaching of the present invention, however, a preferred embodiment of the present invention would include securing the deck to rails 305 in order to slidably secure the deck to the frame provided by roller assembly rails 305 and mounting slats 335, which are securely mounted to the bed or floor of a vehicle for use as shown in FIG. 1.

The sliding deck 210 of the present invention is a horizontally moveable about the rollers 315 and slidably secured by the frame provided by the roller assembly rails 305 and slats 335, with load support being provided by the rollers 315 and security being provided by the vehicle-mounted roller assembly rails 305. The rollers 315 are attached to the roller assembly rails 305 in a manner that facilitates rotational movement of the rollers, which in turn enables movement of the slidable deck 210 in an outward and inward, horizontal motion with respect to a vehicle's storage compartment (i.e., a truck bed). A square, or “box”, tube frame can be used for the slats 225 to allow the resulting frame formed from the roller assembly rails 305 and slats 335 to be bolted down to the floor of any motor vehicle, such as a truck's bed. The I-beam frame 220, rails 305 and slats 335 can all be formed from aluminum extruded material or can be formed from metal.

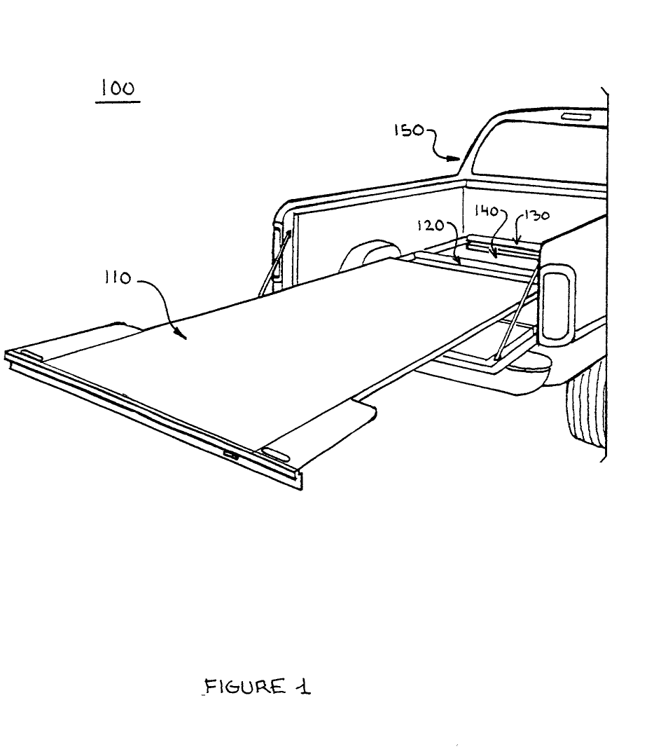

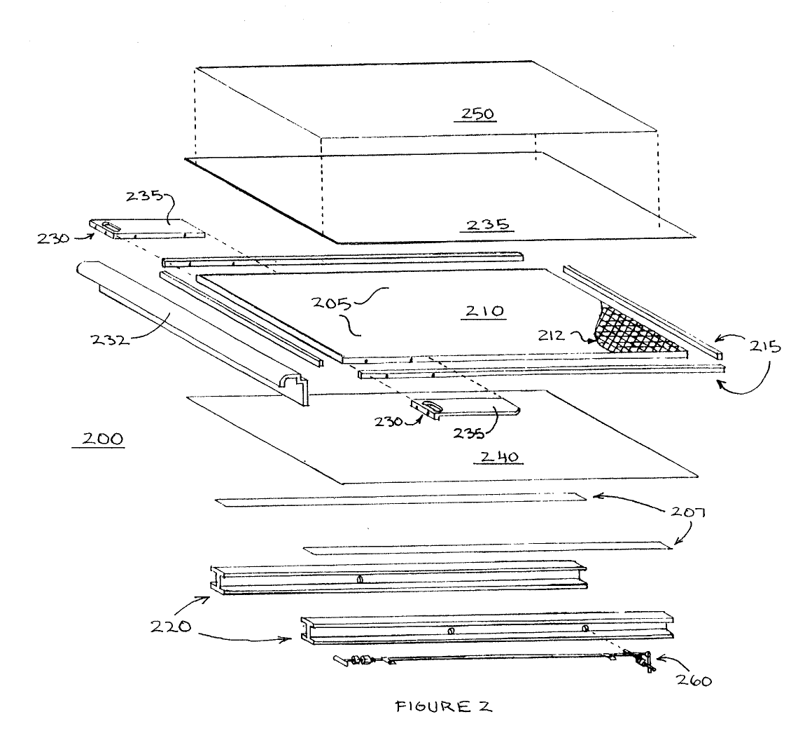

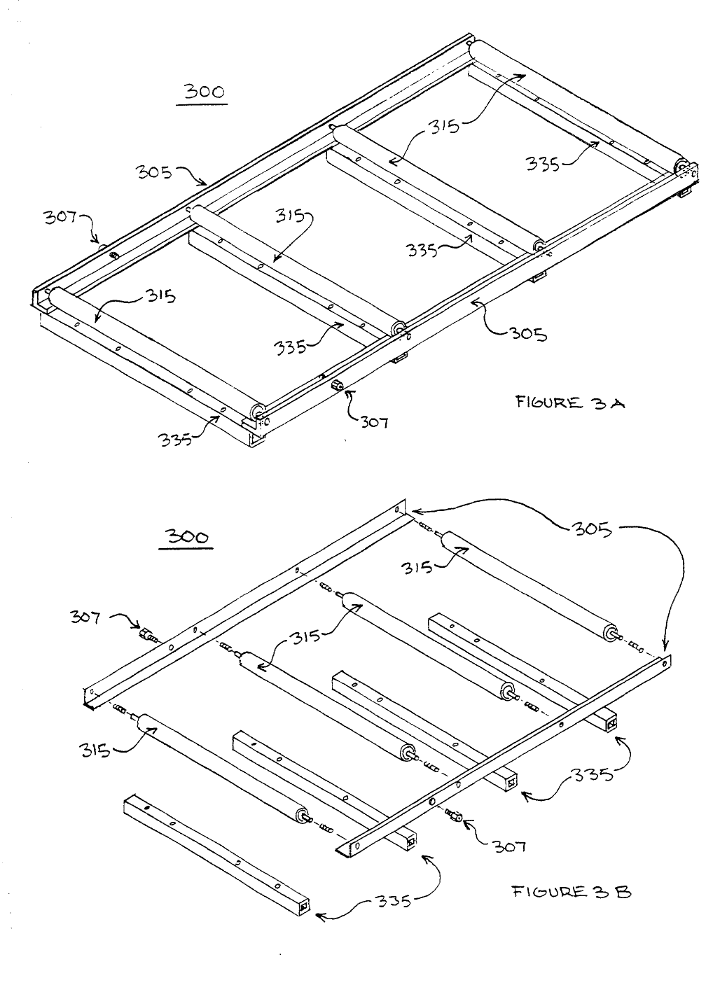

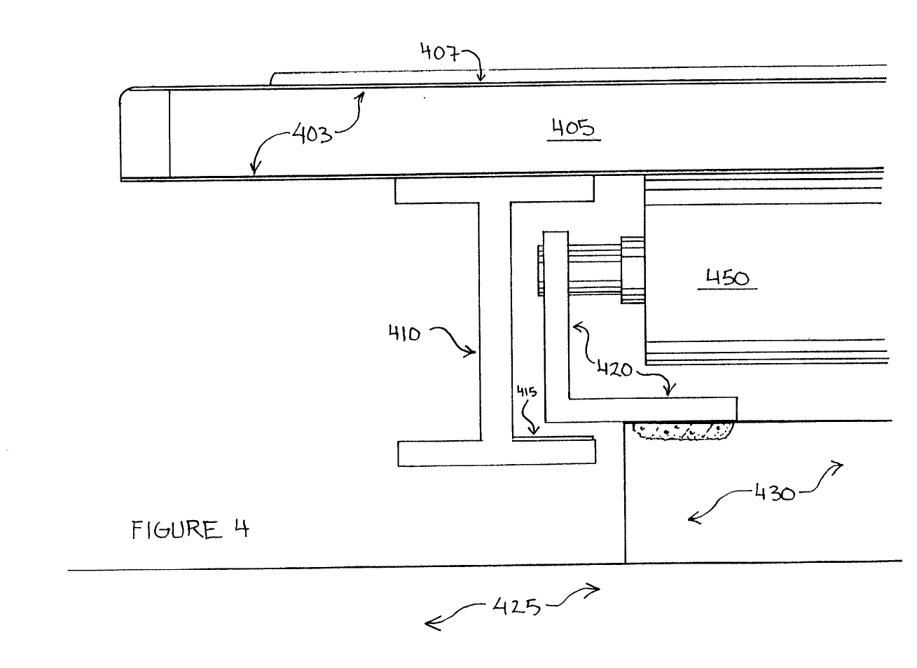

Referring to FIG. 4, a horizontal cross sectional view of an assembled system (both upper 200 and lower 300 units attached to a motor vehicle) in accordance with the teachings of the present invention is shown. Because the angled aluminum rails 420 are supported and secured by, for example, the bed 425 of a pickup truck via box tubing 430, the bottom edge of the I-beams rails 410 associated with the deck 405 can be captured by the bottom edge of the roller assembly rails 420 of the lower unit stage 300. The connection of the upper 200 and lower 300 unit stages as described herein via aluminum I-beams 410 and rails 420 create a sort of cantilevered rail unit. A thin strip of Teflon tape 415 can be placed between the capturing edges of the aluminum edges/surfaces to relieve friction build-up between the rail/I-beam interface of the upper 200 and lower 300 unit stages. The deck 405 can be surfaced with aluminum layers 403 for added stability and subsequent layers of protective material 507 can be placed on the upper surface of the deck 405 for protection and operational purposes (e.g., nonslip or nonskid surface). The deck 405 is usually in continuous contact at its lower surface with rollers 450, where direct weight-bearing support to the deck 405 and its load is provided.

Referring to FIG. 5, a perspective view of a full assembly of the present invention is shown. A lower surface planar view of the present invention is shown. The front area 503 of the deck 505 can have oval hand cutouts 510 formed through it for providing manual control over the deck's 505 movement with respect to the rollers 507 and associated mechanics described herein. The oval hand cutouts 510 can provide safety to the user of the invention in that hand operation is always from the top of the deck 505, away from the moving parts of the mechanical assembly (e.g., roller 507, locking mechanism 520) located underneath the deck. It should be appreciated that a handle assembly 232 as shown in FIG. 2 can also be used in addition to, or in place of, hand cutouts 510.

A position locking mechanism 520 can also be located along the right or left side of the support I-beam 515 underneath the deck 505. The locking mechanism 520 can be provided as a cable, angled steel bar or rod 525 and spring assembly 530 located on the I-beam 515 and deck 505 underside. The locking mechanism 520 would be in fixed attachment to the I-beam 515 and can allow the cable, bar or rod 525 to pass through holes in the I-beam 515 and capture holes formed at various intervals in the fixed angle support rails 530. The position locking mechanism 520 can be located near the end 535 of the I-beam 515, opposite the front end 503 of the deck 505, and can be controlled by the control rod 525 and handle accessible either through a hand cutout 527, or on the lower surface of the deck 505 near its front area 503. The locking mechanism 520 can also allow the user to stop forward movement of the deck 505 into a vehicle at various points of deck extension.

The deck 505 can preferably extend up to approximately 70% of its length where it can still be capable of bearing loads exceeding 1500 pounds. An effective yet simple stopping mechanism 540 can preclude the possibility of overextending the deck 505 by limiting its overall extension length. A stopping mechanism 540 can prevent the deck 505 from sliding outward from its stowed position within the vehicle it is mounted to when the deck 505 reaches 70% extension, or outward travel. The stopping mechanism 540 can take the form of bolts mounted on the either or both sides of the angled (bed) rails and the I-beams in such a manner than when a first set of bolts 545 fixed on the I-beam 515 comes into contact with a second set of bolts 540 fixed on the angled rails 550, the decks 505 movement is halted. Thus, the bolts 540, 545 act as a final stop for the deck 505 at, for example, 70% extension.

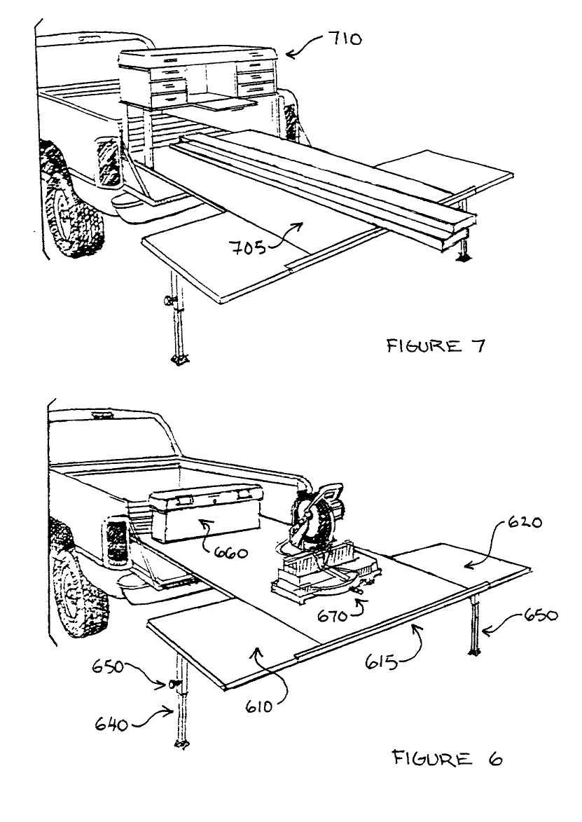

Referring to FIG. 6, another embodiment of the present invention is illustrated. As shown in FIG. 10, extensions 610, 620 (e.g., similar to extension wings 235 shown in FIG. 2) can be attached to left and right of the deck 605 near the head portion (front) of the deck 605. Another embodiment of the invention shown in FIG. 6 includes use of support legs 640, 650 located again near the head portion 630 of the deck 605. The support legs 640, 650 can either be secured by the extensions 610, 620 respectively as shown in FIG. 6, or the support legs can be integrated with or fastened underneath the head of the deck itself. Fastening of the deck extensions 610, 620 and support legs 640, 650 to the deck 605, or of support legs 640, 650 to the deck extensions 610, 620 can be facilitated by mechanical means and methods well known in the art. For example, the extensions 610, 620 can be hinged to the deck 605, or can be slid into a grove (not shown) associated with the edge of the deck 605. Leg extensions 640 and 650 can be fastened to the deck 605 or deck extension 610, 620 also using a hinge (not shown) and can also be lock in to a storage position using fastening means known in the art (e.g., locks, pins, bolts, screws).

The support legs can also be adjustable as shown by knobs 650 in FIG. 6. Adjustment of leg length can be useful where terrain around the work area is uneven. Leg length can also be adjusted using pins or locking means well known in the art. As well known in the art, a knob 650 as shown integrated with leg extension 640 in FIG. 10 can be inserted into a plurality of adjustment holes (i.e., not shown) associated with the upper and lower portions of the leg extensions.

Also shown in FIG. 6 are a storage container 660 and a tool 670 secured to the deck 605. The storage container 660 can be a toolbox, material storage container, or cooler. The tool 670 shown in a saw, but it should be appreciated that many other tools and containers can be secured to the deck 605 and benefit from the advantaged of the present invention.

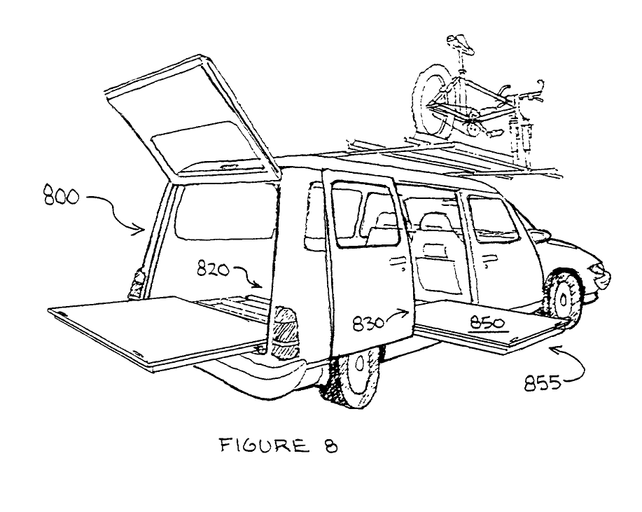

FIG. 7 illustrates another application of the present invention whereby a combination toolbox/worktable 710 is securely mounted to the deck 705.

Referring to FIG. 8, yet another embodiment of the present invention is shown wherein a van 800 is adapted to that takes advantage of the present invention at two locations, a rear cargo area 820 and a side slider-door 830.

It should be appreciated that the present invention would be a useful adaptation for vehicles modified for the disabled. The side deck 850 in FIG. 8 can be modified to tilt downward towards the curb 855 or earth in order to enable ramp access to the vehicle 800. Tilting action of the deck 850 can be achieved by means known in the art, but especially given the teachings of the present invention. For example, as discussed above with respect to FIG. 5, bolts can be secured to the I-beam and angled rails to stop the deck from sliding beyond, for example, a 70% extension. In a ramp application, however, bolts or metal hooks (not shown) can be located at the outermost extension ends of the respective I-beams and angled rails in order to achieve full extension of the side deck 850 in order to enable angular rotation of head end of the deck towards the ground.

It should be appreciated that electrical hook-ups or power connections can be integrated with the present invention's deck to provide power for electric tools or equipment. Power can be provided to the present invention's outlets via job site power outlets, power generation units or batteries. The availability of power connection on the present invention reduced the need for multiple extensions cords to the work area provided by the Present invention.

Computer generated graphics printed on an impact resistant can be easily installed on the deck's upper surface for purposes of advertising or design. A mat having a high-resolution photographic quality graphics can be provided in a variety of colors and designs. Application might include a company logo and name, college logo, favorite sports team, or any aesthetic image of choice. The mat, with graphics, is lightweight, durable, flame retardant, waterproof, and resistant to heat, impact, chemicals and abrasion. The mat with custom or standard graphics can be ordered at time of purchase of the present invention or at a later date.

As may be appreciated by those skilled in the art, the present invention can be included and/or utilized with a wide variety of accessories including extension wings, tool boxes, compartment boxes, loading ramps, dump buckets/tubs, ski boxes, rifles boxes, fishing boxes, bungee/tow cords eyelets/rings and tie downs.

The present invention can facilitate easier handling of materials used in manufacturing, construction, and cargo handling as well as in simple personal use for home maintenance activities and shopping. Any project that requires the full and easy access to the bed of a pickup truck, van, SUV or other utility vehicle can benefit from use of the present invention. Loading concrete blocks or sack of cement, plywood sheets, firewood, furnishings and other heavy and/or bulky materials can now be carried out with ease using the present invention. In commercial applications, workers will encounter ease of handling materials and thereby provide efficient and rapid movement from task to task with minimal energy waste or loss of time. The Present invention, once installed onto a motor vehicle, should be capable of supporting loads exceeding approximately 1500 pounds. The present invention, fully assembled and ready to install, can weigh approximately 180 pounds. Those skilled in the art will appreciate that such values are exemplary only and are not to be considered as limiting features of the present invention.

The foregoing detailed description of the invention is provided to aid those skilled in the art in practicing the present invention. Even so, the detailed description of the invention should not be construed to unduly limit the present invention, as those of ordinary skill in the art may make modifications and variations in the embodiments herein discussed without departing from the spirit or scope of the present invention.

What is claimed is:

1. A motor vehicle mounted cargo carrier, comprising:
a frame securely mounted to a floor associated with a cargo containing area of a motor vehicle, said frame further including a plurality of rollers rotatably attached to said frame; and
a deck having an upper surface and a lower surface, said deck supported by said rollers at said lower surface, wherein said deck can slide along said rollers from a stowed position within said cargo containing area to an extended position with respect to said cargo containing area.

2. The invention of claim 1, wherein said deck is further comprised of honeycomb material construction.

3. The invention of claim 2, said deck further comprised a layer of aluminum forming said upper surface.

4. The invention of claim 3, wherein said deck further comprises a layer of aluminum forming said lower surface.

5. The invention of claim 1, further comprising a locking mechanism for locking said deck at outwardly positions along said frame, with respect to said cargo area.

6. The invention of claim 1, further comprising a stopping mechanism for limiting outwardly extension of said deck.

7. The invention of claim 1, further comprising a handle means for providing a user control of movement over said deck.

8. The invention of claim 1, further comprising at least one deck extension wing for extending the surface of said deck is placed into said extended position.

9. The invention of claim 1, further comprising leg supports wherein said leg supports can be coupled to said lower surface of said deck when placed into said extended position and said leg supports provide ground contact to provide support to said deck.

10. The invention of claim 1, further comprising rails integrated with said lower surface of said deck wherein said deck is slidably secured by said frame such as to enable said deck to slide along said rollers into said stowed and said extended positions.

11. A motor vehicle cargo carrying system, comprising:
a frame securely mounted to a floor associated with a cargo carrying area of a motor vehicle;
a plurality of rollers rotatably attached to said frame; and
a deck further including rails slidably secured by said frame;
wherein said deck, slidably secured by said frame with said rails, can slide along said rollers from a stowed position to an extended position with respect from a cargo containing area within said motor vehicle thereby facilitating the loading, carrying and unloading of cargo within said motor vehicle and on said deck.

12. The invention of claim 11, wherein said deck is further comprised of honeycomb material construction.

13. The invention of claim 12, said deck further comprised a layer of aluminum forming said upper surface.

14. The invention of claim 13, wherein said deck further comprises a layer of aluminum forming said lower surface.

15. The invention of claim 11, further comprising a locking mechanism for locking said deck at outwardly positions along said frame.

16. The invention of claim 11, further comprising a stopping mechanism for limiting outwardly extension of said deck.

17. The invention of claim 11, further comprising a handle means for providing a user control of movement over said deck.

18. The invention of claim 11, further comprising at least one deck extension wing for extending the surface of said deck is placed into said extended position.

19. The invention of claim 11, further comprising leg supports wherein said leg supports can be coupled to said lower surface of said deck when placed into said extended position and said leg supports provide ground contact to provide support to said deck.

20. The invention of claim 17, further comprising a stopping mechanism for limiting outwardly extension of said deck.

21. The invention of claim 20, further comprising a locking mechanism for fixing outwardly extension of said deck at locking points along said frame.

22. The invention of claim 21, further comprising leg supports wherein said leg supports can be coupled to said lower surface of said deck when placed into said extended position and said leg supports provide ground contact to provide support to said deck.

23. The invention of claim 22, further comprising leg supports wherein said leg supports can be coupled to said lower surface of said deck when placed into extended position and said leg supports provide ground contact to provide support to said deck.

24. The invention of claim 16, wherein said deck is further comprised of honeycomb material construction.

25. The invention of claim 24, said deck further comprised a layer of metallic material forming said upper surface.

26. The invention of claim 25, wherein said deck further comprises a layer of metallic material forming said lower surface.

27. The invention of claim 16, further comprising at least one deck extension wing for extending the surface area of said deck is placed into said extended position.

28. The invention of claim 16, further comprising leg supports wherein said leg supports can be coupled to said lower surface of said deck when placed into said extended position and said leg supports provide ground contact to provide support to said deck.

29. A system associated with a motor vehicle for carrying cargo, said system including:
a lower unit assembly further comprising a frame securely mounted to a floor associated with a cargo containing area of a motor vehicle and a plurality of rollers rotatably attached to said frame; and
an upper unit assembly further comprising a plastic honeycomb material deck having an upper surface and a lower surface and I-beam rails secured to said lower surface of said plastic honeycomb material deck;
wherein said upper unit assembly is slidably secured by said I-beam rails to said frame of said lower unit assembly such that said plastic honeycomb material deck is enabled to glide along said plurality of rollers from a stowed position to an extended position with respect from a cargo containing area within said motor vehicle thereby facilitating the loading, unloading and carrying of cargo within said motor vehicle and onto said deck.

30. The invention of claim 29, further comprising a stopping mechanism for limiting outwardly extension of said deck.

31. The invention of claim 29, said deck further comprised a layer of aluminum forming said upper surface.

32. The invention of claim 31, wherein said deck further comprises a layer of aluminum forming said lower surface.

33. The invention of claim 29, further comprising a locking mechanism for locking said deck at outwardly positions along said frame when deck is extended with respect to said cargo-containing area.

34. The invention of claim 29, further comprising a handle means for providing a user control of movement over said deck.

35. The invention of claim 34, further comprising a stopping mechanism for limiting outwardly extension of said deck.

36. The invention of claim 29, further comprising at least one deck extension wing for extending the surface area of said deck when it is placed into extended positions.

37. The invention of claim 29, further comprising leg supports wherein said leg supports can be coupled to said lower surface of said deck when placed into said extended position and said leg supports provide ground contact to provide support to said deck.
